(19) United States
(12) Patent Application Publication
(10) Pub. No.: US 2013/0051746 A1
(43) Pub. Date: Feb. 28, 2013

(54) OPTICAL WAVEGUIDE, OPTICAL TRANSMISSION MODULE, AND ELECTRONIC DEVICE

(71) Applicants: Ryo Yamamoto, Kyoto-shi (JP); Kentaro Hamana, Okayama (JP); Yuji Hirose, Kyoto (JP); Yuichi Suzuki, Shiga (JP); Naru Yasuda, Kyoto (JP); Hayami Hosokawa, Kyoto (JP)

(72) Inventors: Ryo Yamamoto, Kyoto-shi (JP); Kentaro Hamana, Okayama (JP); Yuji Hirose, Kyoto (JP); Yuichi Suzuki, Shiga (JP); Naru Yasuda, Kyoto (JP); Hayami Hosokawa, Kyoto (JP)

(73) Assignee: OMRON CORPORATION, Kyoto (JP)

(21) Appl. No.: 13/493,404

(22) Filed: Jun. 11, 2012

(30) Foreign Application Priority Data
Aug. 31, 2011 (JP) 2011-189624

(51) Int. Cl. G02B 6/02

(52) U.S. Cl. 385/123

(57) ABSTRACT

An optical waveguide has a clad, a core surrounded by the clad and having an index of refraction larger than an index of refraction of the clad, an incident end face that makes light enter the core; and an exiting end face that makes light exit from the core. Two side faces of the optical waveguide are formed so as to have an angle change. The two side faces are translationally symmetric with each other, or two side faces excluding a portion of the side faces are translationally symmetric with each other.

### BACKGROUND OF THE INVENTION

1. Technical Field

The present invention relates to an optical waveguide, an optical transmission module and an electronic device.

2. Related Art

In recent years, along with the development of a high-definition LCD (Liquid Crystal display) in a mobile phone, speeding up data transmission rate has been required between the LCD and an application processor. Furthermore, with the progress of a thinner mobile phone with increased built-in functions, both lowering height and space-saving for a wiring and a connecting part (connector) have been required. Based on such a background, realizing mass data transmission by optical wiring is under study, and an optical waveguide that conducts data transmission between circuit boards by using an optical signal is being developed.

As an example, a film-like optical waveguide used in a state in which the optical waveguide is wrapped around a hinge is described in Japanese Unexamined Patent Publication No. 2006-259009. The above-described optical waveguide winds at two parts, each of which has an angle α and an angle β, respectively, and an optical waveguide film with rather small optical loss can be provided when used in the state in which the optical waveguide is wrapped around the hinge.

However, production efficiency of the optical waveguide in Japanese Unexamined Patent Publication No. 2006-259009 is low.

That is, while three core patterns are included in a winding optical waveguide film in Japanese Unexamined Patent Publication No. 2006-259009, this optical waveguide film is produced by laminating a polyimide layer and the like, which are produced individually. That is, producing a large number of the optical waveguides is not taken into consideration in Japanese Unexamined Patent Publication No. 2006-259009.

Therefore, it is difficult to manufacture a plurality of optical waveguides efficiently by using the art of Japanese Unexamined Patent Publication No. 2006-259009, where the production efficiency is low because a tact time for manufacturing the optical waveguides becomes long.

### SUMMARY

One or more embodiments of the present invention provides an optical waveguide that can be manufactured with high production efficiency.

According to one or more embodiments of the present invention, there is provided an optical waveguide having a clad and a core, which is surrounded by the clad and has an index of refraction higher than that of the clad, including: an incident end face for making light enter the core; and an exiting end face for making light exit from the core, wherein two side faces of the optical waveguide are formed so as to have an angle change, and the two side faces are translationally symmetric with each other, or side faces excluding a portion of the side faces are translationally symmetric with each other.

According to one or more embodiments of the invention, since the two side faces or side faces excluding a portion of the side faces are translationally symmetric with each other, in a manufacturing process of the optical waveguide, and when the optical waveguide is cut out from a large-sized optical waveguide material, by cutting the optical waveguide material in a cutting pattern in which substantially the same shapes as that of optical waveguide adjoin, a plurality of optical waveguides can be obtained. Accordingly, there can be provided an optical waveguide with high production efficiency.

Furthermore, in an optical waveguide according to one or more embodiments of the present invention, the two side faces have an angle change at least at two parts.

With the above shape employed, degree of freedom can be increased when the positions of the incident end face and the exiting end face are set.

Furthermore, in an optical waveguide according to one or more embodiments of the present invention, an acute angle between angles which the incident end face and the side face make and an acute angle between angles which the exiting end face and the side face make are larger than 0 degree and are smaller than 90 degrees.

As mentioned above, by providing an angle smaller than 90 degrees, the variation of an optical waveguide can be increased. In particular, when the two side faces have an angle change at least at two parts, and if the clad has a constant width, the width of an intermediate area (an area which does not include the incident end face and the exiting end face) of the clad can be set widely. Accordingly, the strength of an area, which has the angle change, of the clad can be enhanced.

Furthermore, in an optical waveguide according to one or more embodiments of the present invention, an interior angle between the angles of parts having an angle change is larger than 0 degree and is 90 degrees or smaller.

In an electronic device provided with a hinge, data transmission is conducted between two members arranged via a hinge. In an optical waveguide according to one or more embodiments of the present invention, with the above-mentioned angle setting, an optical waveguide with a shape in which one part has an angle change greatly (an interior angle is 90 degrees or smaller) or a crank-type optical waveguide is possible, and there can be provided an optical waveguide which is suitable for an electronic device provided with a hinge.

Furthermore, in an optical waveguide according to one or more embodiments of the present invention, the above-mentioned interior angle is 85 degrees or larger and is 90 degrees or smaller.

With the above-mentioned angle setting, a shape of a part having an angle change can be close to a right-angled shape, and there can be provided an optical waveguide which is even more suitable for an electronic device.

Furthermore, in an optical waveguide according to one or more embodiments of the present invention, in a plane including the core in the incident end face and the core in the exiting end face, one angle between angles, which are made between a straight-line connecting the central point of a core width at a position 0.1 mm distant in the perpendicular direction from at least one end face of the incident end face and the exiting end face and the central point of a core width in the one end face and at least the one end face, is 75 degrees or larger and is 105 degrees or smaller.

With the one angle between the angles falling within the above-mentioned range, when light enters from the end face, the angle of the light relative to a plane perpendicular to the upper face of the clad can be a right-angle or an approximate right angle, resulting in suitable light incidence. As a result, optical loss can more hardly be produced, which realizes enhanced coupling efficiency.

Furthermore, in an optical waveguide according to one or more embodiments of the present invention, the core includes a curved-line shape.

Thus, while light enters from one end face and exits from the other end, optical loss is hardly produced in the core, which realizes small optical coupling loss.

Furthermore, in an optical waveguide according to one or more embodiments of the present invention, the core is formed so as to pass through at least once at least one of the median line of two side faces in an area including the incident end face in the clad and the median line of two side faces in an area including the exiting end face in the clad.

Thus, the core is formed in a state in which the core passes through the median line of the clad width in the area including at least the incident end face and the exiting end face, and the core is to be formed in a wide range. As a result, it is possible to set the maximum curvature of a curved-line-shaped core to be small.

Furthermore, in an optical waveguide according to one or more embodiments of the present invention, the maximum curvature of the curved-line-shaped core is 0.25 mm⁻¹ or smaller.

Thus, the core has a smooth shape, and optical loss is hardly produced when light is transmitted in the core, which realizes small optical coupling loss.

Furthermore, in an optical waveguide according to one or more embodiments of the present invention, the width of an area including the incident end face in the clad is larger than the width of an area having an angle change relative to an area including the incident end face and that the width of an area including the exiting end face in the clad is larger than the width of an area having an angle change relative to an area including the exiting end face.

Thus, the core can be formed so that the curvature becomes small in the intermediate area having an angle change relative to the area including the incident end face or the exiting end face, and optical loss is hardly produced when light is transmitted in the core, which realizes small optical coupling loss.

Furthermore, in an optical waveguide according to one or more embodiments of the present invention, a portion of the core is formed in a straight-line shape along the median line of the two side faces in a plane including the incident end face and the exiting end face.

According to the above configuration, there is a merit that the shape of an optical waveguide can be easily modified by adjusting the length of the straight-line shape with portions of the core except for the straight-line shape remaining unchanged.

Furthermore, in an optical waveguide according to one or more embodiments of the present invention, the core has an inflection point at least in one of an area having an angle change relative to an area including the incident end face and an area having an angle change relative to an area including the exiting end face.

According to the above shape, the core can be formed in a shape that is smooth around the inflection point, and optical loss in the core is hardly produced.

Furthermore, in an optical waveguide according to one or more embodiments of the present invention, side faces excluding a portion of the side faces are translationally symmetric with each other and that the portion of the side faces is a concave shape or a convex shape.

According to such an optical waveguide, the concave shape or the convex shape can be used as a mark when the optical waveguide is incorporated in an optical transmission module etc., which can improve accuracy in assembling.

In the optical waveguide according to one or more embodiments of the present invention, a reflective surface is formed on the incident end face and the exiting end face for making light enter the core or exit from the core.

Thus, it becomes possible to make the light enter the optical waveguide from the perpendicular direction, and there can be provided an optical waveguide which is suitably usable as a part of a thinner optical transmission module.

Furthermore, in an optical waveguide according to one or more embodiments of the present invention, an electrical wiring is laminated on the clad.

Thus, the optical waveguide can be configured with the electrical wiring being in close contact with the clad. In addition, since data transmission by an electric signal is possible, there can be provided an optical waveguide which is easily mounted on an electronic device and the like which have employed a data transmission system by electricity.

Furthermore, the optical transmission module according to one or more embodiments of the present invention includes the optical waveguide, a light transmitting unit that makes light enter the incident end face to transmit information, a light receiving unit that receives the light exiting from the exiting end face to receive the information.

Furthermore, the electronic device according to one or more embodiments of the present invention includes the optical transmission module.

Furthermore, the electronic device according to one or more embodiments of the present invention includes an information input section, an information display section and a hinge; the information input section and the information display section are pivotable along the hinge and are configured in a foldable structure; an area having an angle change relative to an area including the incident end face in the clad is arranged on the hinge.

As described above, the optical waveguide according to one or more embodiments of the present invention includes the incident end face for making the light enter the core and the exiting end face for making the light exit from the core. Two side faces of the optical waveguide is formed so as to have an angle change, and the two side faces are translationally symmetric with each other, or side faces excluding a portion of the side faces are translationally symmetric with each other.

As described above, since the two side faces are translationally symmetric with each other or side faces excluding a portion of the side faces are translationally symmetric with each other, in a manufacturing process of the optical waveguide, and when the optical waveguide is cut out from a large-sized optical waveguide material, by cutting the optical waveguide material in a cutting pattern in which substantially the same shapes as that of optical waveguide adjoin, a plurality of optical waveguides can be obtained. Accordingly, there is an effect that the optical waveguide can be provided with high production efficiency.

### BRIEF DESCRIPTION OF THE DRAWINGS

FIGS. 1A to 1D are diagrams relating to an optical waveguide according to an embodiment of the present invention, where FIG. 1A is a side view showing the optical waveguide, FIG. 1B is a side view showing a variant of the optical waveguide, FIG. 1C is a plan view showing the optical waveguide, and FIG. 1D is a plan view of an optical waveguide material before the optical waveguide is formed;

FIG. 2 is a plan view showing a variant of the optical waveguide according to an embodiment of the present invention;

FIGS. 3A to 3D are diagrams showing an optical waveguide according to another embodiment of the present invention, where FIG. 3A is a perspective view showing the optical waveguide, FIG. 3B is a perspective view showing a variant of the optical waveguide, FIG. 3C is a plan view showing the optical waveguide, and FIG. 3D is a plan view showing an optical waveguide material before the optical waveguide is formed;

FIGS. 4A and 4B are diagrams of an optical waveguide according to another embodiment of the present invention, where FIG. 4A is a plan view showing the optical waveguide, and FIG. 4B is a plan view showing an optical waveguide material before the optical waveguide is formed;

FIGS. 5A and 5B are diagrams of an optical waveguide according to another embodiment of the present invention, where FIG. 5A is a plan view showing the optical waveguide, and FIG. 5B is a plan view showing an optical waveguide material before the optical waveguide is formed;

FIGS. 6A to 6C are diagrams of an optical waveguide according to another embodiment of the present invention, where FIGS. 6A and 6B are plan views showing the optical waveguide, and FIG. 6C is a plan view showing an optical waveguide material before the optical waveguide is formed;

FIGS. 7A to 7C are diagrams of an optical waveguide according to another embodiment of the present invention, where FIGS. 7A and 7B are plan views showing the optical waveguide, and FIG. 7C is a plan view showing an optical waveguide material before the optical waveguide is formed;

FIGS. 8A to 8C are diagrams of an optical waveguide according to another embodiment of the present invention, where FIGS. 8A and 8B are plan views showing the optical waveguide, and FIG. 8C is a plan view showing an optical waveguide material before the optical waveguide is formed;

FIG. 9 is a plan view showing a variant of the optical waveguide according to one or more embodiments of the present invention;

FIG. 10A is a plan view showing a mobile phone provided with a hinge, and FIGS. 10B and 10C are plan views showing a state in which an optical waveguide is arranged along the hinge;

FIGS. 11A to 11C are diagrams showing an optical waveguide according to an embodiment of the present invention, where FIG. 11A is a plan view showing the optical waveguide, FIG. 11B is a perspective view showing the optical waveguide, and FIG. 11C is a side view showing the optical waveguide;

FIG. 12 is a graph showing measured results of coupling efficiency when an angle A3 is varied for an optical waveguide according to an embodiment of the present invention;

FIG. 13 is a plan view showing an optical waveguide according to an embodiment of the present invention;

FIG. 14 is a plan view showing an optical waveguide according to a variant of an embodiment of the present invention, as viewed from the direction toward the surface of a clad;

FIG. 15A is a block diagram showing an optical transmission module according to an embodiment of the present invention, and FIG. 15B is a block diagram showing the detailed structure of a data line;

FIG. 16 is a side view showing an optical waveguide, a CPU-side board and a light emitting element according to an embodiment of the present invention;

FIG. 17 is a plan view showing an optical waveguide according to one or more embodiments of the present invention;

FIGS. 18A to 18C are plan views showing a mobile phone according to an embodiment of the present invention; and

FIG. 19A is a plan view showing a mobile phone according to an embodiment of the present invention, and FIGS. 19B and 19C are process drawings showing a manufacturing process of the mobile phone.

### DETAILED DESCRIPTION

### Optical Waveguide

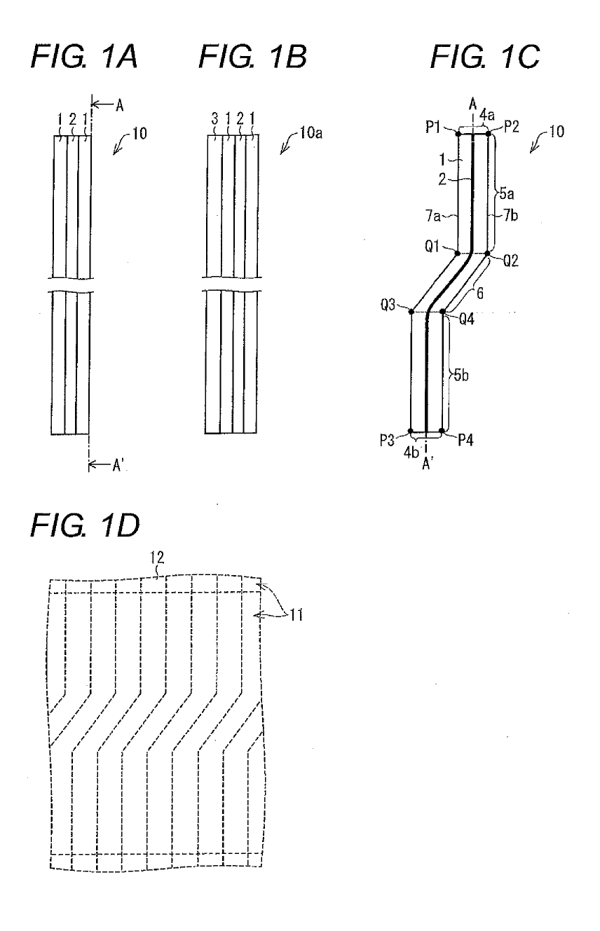

Embodiments of the present invention are described below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. Based on FIG. 1, an embodiment of the present invention will be described as follows. First, an optical waveguide according to an embodiment of the present invention will be described. FIG. 1A is a side view showing the optical waveguide 10, which includes a clad 1 and a core 2. In other words, the core 2 is surrounded by the clad 1.

The optical waveguide 10 has an end face (incident end face) 4a and another end face (exiting end face) 4b. The core 2 is exposed at the end faces 4a and 4b, but may be covered with a prescribed coating agent at the end faces 4a and 4b. When the same member repeatedly appears, the name of the member will be omitted for the latter appearance. That is, “end faces 4a and 4b” is synonymous with “end face 4a and end face 4b”. The same rule is applied to other members.

The clad 1 and the core 2 are formed of translucent materials, and the index of refraction of the core 2 is larger than that of the clad 1. Thus, light entering the core 2 at the end face 4a or 4b is transmitted in the direction of optical transmission by repeating total reflection inside the core 2.

As a material that forms the clad 1 and the core 2, it is possible to use glass, a plastic or the like. However, in order to form the optical waveguide 10 having sufficient flexibility, one or more embodiments of the present invention employs resin materials, such as an acrylic based, an epoxy based, a urethane based, or a silicone based resin material. A polyimide film and the like are included as specific resin.

The length of the clad 1 is not limited in particular and is dependent on the design of a product in which the optical waveguide 10 is incorporated. That is, depending on a distance which the light travels between the incidence and the exiting, the positions of the end faces 4a and 4b are changed, and the length of the clad 1 is determined. The length of the core 2 is determined in a similar manner.

As the width of the clad 1 is larger, the strength of the clad 1 improves. On the other hand, as the width of the clad 1 becomes larger, it becomes difficult to miniaturize the optical waveguide 10. Since the strength of the clad 1 is dependent on the kind of a material, it is difficult to uniquely specify the strength. However, from a viewpoint that the optical waveguide 10 is miniaturized and is also provided with a required minimum strength, according to one or more embodiments of the present invention, the width of the clad 1 is 0.3 mm or larger and 5.0 mm or smaller, and according to one or more embodiments of the present invention, the width of the clad 1 is 0.5 mm or larger and 3.0 mm or smaller.

Since the light is transmitted via the core 2, the core 2 has an elongated shape. The cross-sectional shape of the core 2 is not limited in particular, and may be a square, a rectangle, a circle and an ellipse, for example.

FIG. 1B shows an optical waveguide 10a, which is a variant of the optical waveguide 10. FIG. 1B is a side view showing the optical waveguide 10a. In the optical waveguide 10a, unlike the optical waveguide 10, a clad 1 is provided on a substrate 3 and a core 2 is surrounded by the clad 1.

The substrate 3 is provided with an electrical wiring, and the substrate 3 and the clad 1 are laminated. Thus, there can be provided an optical waveguide which is used together with data transmission by electricity. Since the substrate 3 is laminated, the optical waveguide 10a can be configured with the electrical wiring being in close contact with the clad 1. Furthermore, since data transmission by an electric signal is possible, there can be provided an optical waveguide which is easily mounted on an electronic device that has employed a data transmission system by electricity. As a material that forms the substrate 3, it is possible to use a publicly known substrate material, and glass epoxy, polyimide and the like are included, for example.

FIG. 1C is a plan view of the optical waveguide 10 for the plane A-A′ of FIG. 1A, as viewed from the direction toward the clad 1. The plane A-A′ is coincident with the surface (upper face) of the clad 1. Here, the surface (upper face) of the clad 1 refers to a face of the clad 1 that is parallel to the transmission direction of light passing through the core 2. As shown in FIG. 1C, the clad 1 is classified into a first area 5a, a second area 5b, and an intermediate area 6. The first area 5a includes the end face 4a, and the second area 5b includes the end face 4b. The intermediate area 6 is located between the first area 5a and the second area 5b.

Here, in a shape of the clad 1 as observed from the direction toward the surface (upper face) of the clad 1, two end points of the end face 4a are called end points P1 and P2, and two end points of end face 4b are called end points P3 and P4. Also in the shape of the clad 1 as observed from the direction toward the surface of the clad 1, two points located at the boundary of the first area 5a and the intermediate area 6 are called first halfway points Q1 and Q2, and two points located at the boundary of the second area 5b and the intermediate area 6 are called second halfway points Q3 and Q4.

Furthermore, in the direction along the core 2, a shape in which the end point P1, i.e. one end point of the first area 5a, and one end point P3 of the second area 5b are connected, is called a first side face (side) 7a. The first side face 7a is a shape in which the end point P1, the first halfway point Q1, the second halfway point Q3 and the end point P3 are connected in a line. On the other hand, in the direction along the core 2, the shape in which the end point P2, i.e. the other end point of the first area 5a, and the other end point P4 of the second area 5b are connected is called a second side face (side) 7b. The second side face 7b is a shape in which the end point P2, the first halfway point Q2, the second halfway point Q4 and the end point P4 are connected in a line.

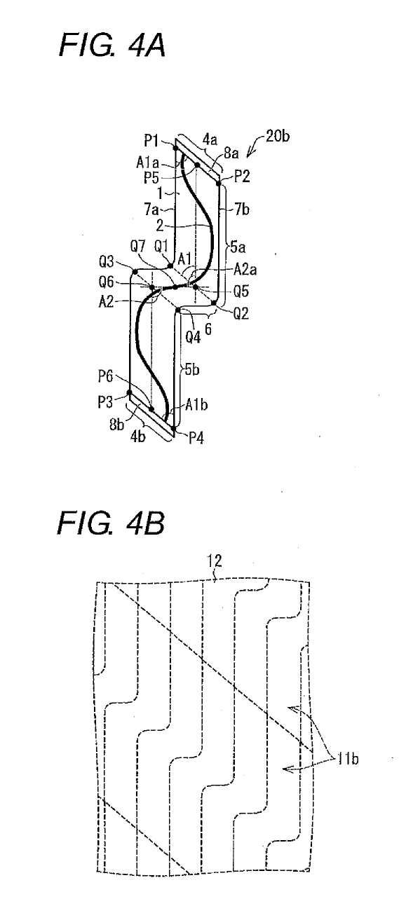

The first halfway points Q1 and Q2 and the second halfway points Q3 and Q4 are points where an angle change is produced on the first side face 7a and the second side face 7b, which are apexes when the first side face 7a and the second side face 7b are configured in a straight-line shape, and which are points where the curvature is the largest in a curved-line shape when the first side face 7a and the second side face 7b are configured in the curved-line shape, as shown in FIG. 4A. If the first side face 7a is translationally moved to the second side face 7b, the first halfway point Q1 coincides with the first halfway point Q2, and the second halfway point Q3 coincides with the second halfway point Q4.

The first side face has: (1) a straight-line shape from the end point P1 to the first halfway point Q1; (2) a straight-line shape from the first halfway point Q1 to the second halfway point Q3; and (3) a straight-line shape from the second halfway point Q3 to the end point P3. Each of the above shapes in (1) to (3) may not be a straight-line shape, but may be a curved-line shape. In particular, according to one or more embodiments of the present invention, a shape in the intermediate area 6 of the first side face 7a from the first halfway point Q1 to the second halfway point Q3 has a curvature. Thus, the shape of the first side face 7a in the first halfway point Q1 and the second halfway point Q3 can be smooth, and cracks and the like are hardly produced at parts of the first halfway point Q1 and the second halfway point Q3. For the shape of the second side face 7b, the same thing can also be mentioned as for the first side face 7a.

The first side face 7a has an angle change from the first area 5a toward the intermediate area 6 and also has an angle change from the second area 5b toward the intermediate area 6, and, in addition, the first side face 7a and the second side face 7b are translationally symmetric with each other.

Here, “having an angle change” may include any lines except for a straight-line. In addition, an angle change includes not only a state in which two line segments have an angle change (a state of winding) but also a state in which there is a gentle curve near the intersection of two line segments (a state in which a curve-radius is included at the portion of winding).

For example, a statement that “a line segment passing though the first halfway point Q1 has an angle change at the first halfway point Q1” may include not only “having an angle change from the first area 5a toward the intermediate area 6” but also “having an angle change from the second area 5b toward the intermediate area 6”. A line segment that connects the end point P1 and the first halfway point Q1 and another line segment that connects the first halfway point Q1 and the second halfway point Q3 intersect with having an angle, which is expressed as “having an angle change”. That is, the first side face 7a has an angle change from the first area 5a toward the intermediate area 6.

A line segment that connects the first halfway point Q1 and the second halfway point Q3 and another line segment that connects the second halfway point Q3 and the end point P3 intersect with having an angle, which is also expressed as “having an angle change”. That is, the first side face 7a has an angle change from the intermediate area 6 toward the second area 5b.

Similar to the first side face 7a, the second side face 7b has an angle change from the first area 5a toward the intermediate area 6 and also has an angle change from the intermediate area 6 toward the second area 5b. That is, the first side face 7a and the second side face 7b never have a straight-line shape. With the first side face 7a and the second side face 7b having an angle change as described above, a shape with high degree of freedom can be selected for areas from the first area 5a to the intermediate area 6 and the second area 5b.

Furthermore, the first side face 7a and the second side face 7b are translationally symmetric with each other. Being “translationally symmetric” implies that moving one of the first side face 7a and the second side face 7b along the prescribed direction of a straight-line with no rotation (moving translationally) results in being coincident, or substantially coincident with the shape of the other. That is, translational symmetry is neither rotation symmetry nor inversion symmetry (plane symmetry).

The above mentioned “substantially coincident” implies that one side face does not need to be thoroughly coincident with the other face, but a portion of one side face may have inclination relative to a portion of the other side face (having an angle change is acceptable). In addition, side faces excluding a portion of the first side face 7a and the second side face 7b may be translationally symmetric with each other. These variants will be mentioned later using FIGS. 4 to 8.

A state in which the same shapes 11 as that of the optical waveguide 10 adjoin with each other is shown in FIG. 1D. FIG. 1D is a plan view showing an optical waveguide material 12, as viewed from the direction toward the surface of the clad 1. The optical waveguide 10 is formed by cutting the optical waveguide material 12 into the shape 11.

The shape 11 cut out from the optical waveguide material 12 is the same as that of the optical waveguide 10, as mentioned above. In the optical waveguide 10, the first side face 7a and the second side face 7b are translationally symmetric with each other, and the first area 5a includes the end face 4a and the second area 5b includes the end face 4b. Thus, the shapes 11, which are same as that of optical waveguide 10, can adjoin with each other via a line segment corresponding to a part to be a side face. The shapes 11 can also adjoin with each other via a line segment corresponding to a part to be an end face. In FIG. 1D, according to one or more embodiments of the present invention, the shapes 11 adjoin with each other via the line segment corresponding to a position to be the side face and via the line segment corresponding to a position to be the end face.

According to one or more embodiments of the present invention, the shapes 11 are arranged so that the parts to be the end face are aligned. When the optical waveguide 10 is cut out from the large-sized optical waveguide material 12, with a plurality of optical waveguides 10 being cut out based on the arrangement of the shape of the optical waveguide 10, the optical waveguides 10 having the same shape can be obtained efficiently. According to this cutting method, the first side face of a certain optical waveguide adjoins a portion to be the second side face of a neighboring optical waveguide. Parts to be the end faces included in the first area of each optical waveguide form an identical plane, and parts to be the end faces included in the second area of each optical waveguide also form another identical plane.

Thus, when N optical waveguides are cut out in a manner such that the end faces adjoin with each other and the side faces also adjoin with each other, by performing very small number of cuttings, i.e. (N−1) time cuttings with respect to the end faces and (N−1) time cuttings with respect to the side faces, the optical waveguides 10 can be efficiently cut out. That is, there can be provided an optical waveguides with high production efficiency. In addition, when the plurality of optical waveguides are cut out, there is an effect that the optical waveguide material 12 is efficiently used, because nothing remains between the optical waveguides in the optical waveguide material 12.

A cutting method of an optical waveguide material as described in one or more embodiments of the present invention is not disclosed in Japanese Unexamined Patent Publication No. 2006-259009. With respect to the cutting of an optical waveguide material, for example, the optical waveguide may be cut out by punching with a die, or the optical waveguide material may be cut out by slicing with an edged tool.

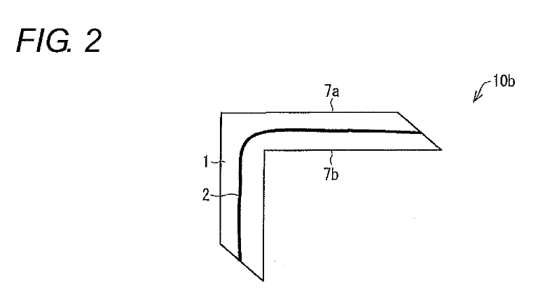

According to one or more embodiments of the present invention, the optical waveguide 10 has an angle change at two parts in a plane including the end point 4a and 4b. With the above shape adopted, degree of freedom can be increased when the positions of the end face 4a and the end face 4b are set. In addition, the optical waveguide according to one or more embodiments of the present invention is formed so that two side faces of the optical waveguide have an angle change. The two side faces just need to be translationally symmetric with each other, and there may be one part that has the angle change. A variant of such an optical waveguide is shown in FIG. 2. FIG. 2 is a plan view showing the optical waveguide 10b according to one or more embodiments of the present invention.

As shown in FIG. 2, the optical waveguide 10b has a winding at one part, and the first side face 7a and the second side face 7b have an angle change and are translationally symmetric with each other, being similar to the optical waveguide 10. Since the first side face 7a and the second side face 7b of the optical waveguide 10b are translationally symmetric, by using a cutting method similar to that shown in FIG. 1D, there can be provided an optical waveguide with high production efficiency.

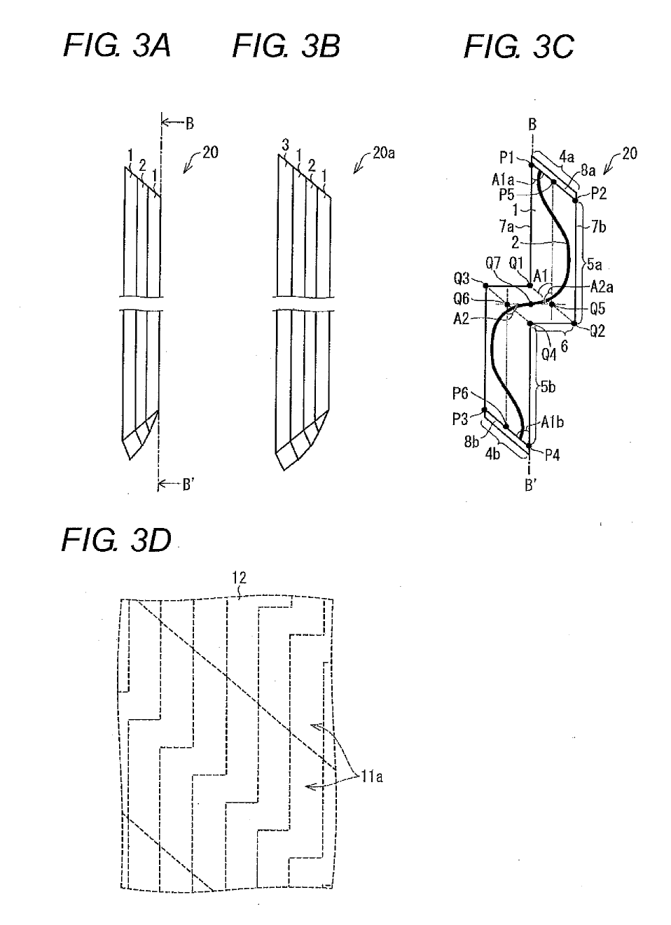

Based on FIGS. 3 to 18, further embodiments of the present invention will be described as follows. For convenience sake in explanation, a member having a function same as that of a member used in FIGS. 1 and 2 is given the same member number, and the explanation thereof will be omitted.

An optical waveguide 20 has been devised so that an optical waveguide having the same or substantially the same shape as that of the optical waveguide 20 can be produced efficiently in a similar manner to that of the optical waveguide 10 according to one or more embodiments.

That is, while a foldable mobile phone is being widely used in recent years, as the mobile phone is miniaturized, the curvature of a core becomes large for a type of an optical waveguide in which the optical waveguide is wound around a hinge, as described in Japanese Unexamined Patent Publication No. 2006-259009, resulting in large optical coupling loss. The inventors created the optical waveguide 20 according to one or more embodiments of the present invention to provide an optical waveguide capable of suppressing the optical coupling loss. The optical waveguide 20 according to one or more embodiments of the present invention includes various features. The optical waveguide 20 will now be described below according to one or more embodiments.

FIG. 3A is a side view showing the optical waveguide 20, and FIG. 3B is a side view showing an optical waveguide 20a that is a variant of the optical waveguide 20. Unlike the optical waveguide 20, the optical waveguide 20a has a substrate 3. FIG. 3C is a plan view showing the optical waveguide 20, as viewed from the direction toward the surface of the clad 1. In FIG. 3A, according to one or more embodiments of the present invention, unlike the optical waveguide 10, reflective surfaces 8a and 8b are formed on the end faces 4a and 4b. The reflective surfaces 8a and 8b may be restated as a reflective layer which makes light enter the core 2 or makes light exit from the core 2. The reflective surfaces 8a and 8b perform the incidence or the exiting of light suitably by reflecting the incident light or the exiting light. The incidence or exiting of light by the reflective surfaces 8a and 8b will be mentioned later in the explanation regarding an electronic device.

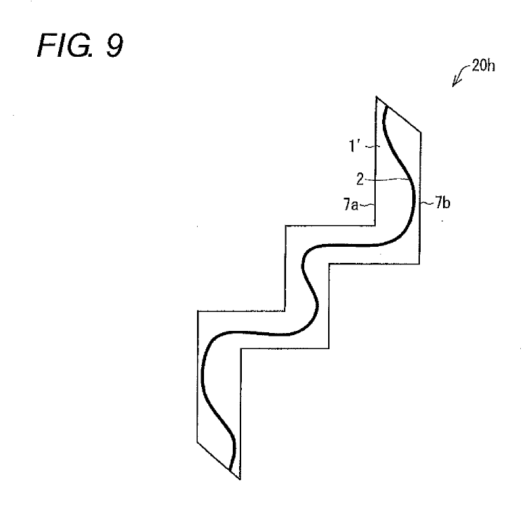

As shown in FIG. 3C, in the optical waveguide 20 according to one or more embodiments, and in the shape of the clad 1 when observed from the direction toward the surface of the clad 1, the first area 5a has a shape characterized such that the two end points P1 and P2 and the two halfway points Q1 and Q2 are connected with each other. The second area 5b has a shape characterized such that the two end points P3 and P4 and the two second halfway points Q3 and Q4 are connected with each other, and the intermediate area 6 has a shape characterized such that the first halfway points Q1 and Q2 and the second halfway points Q3 and Q4 are connected with each other. In the optical waveguide 20, the angle of the clad 1 changes at the first halfway points Q1 and Q2 and also changes at the second halfway points Q3 and Q4, so there are two parts which have an angle change. There may be two or more parts which have an angle change, and such an example will be described later (FIG. 9).

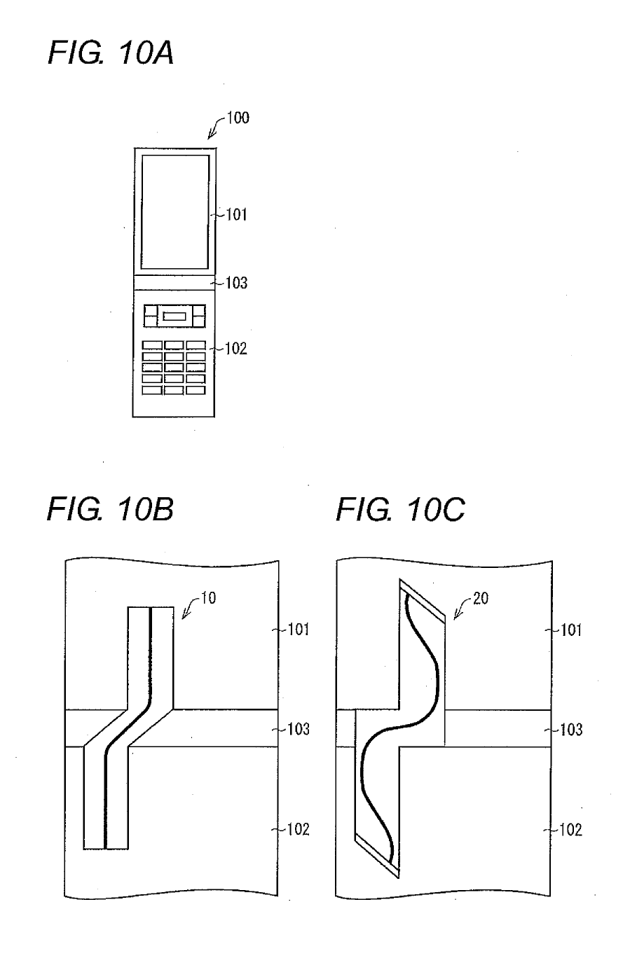

Furthermore, an acute angle A1 between angles made by a straight-line, which connects a middle point P5 between the two end points P1 and P2 and a middle point Q5 between the two the first halfway points Q1 and Q2, and a straight-line, which connects the first halfway points Q1 and Q2, is larger than 0 degree and is smaller than 90 degrees. Since the acute angle A1 and an acute angle A1a and A1b are the same angles, the acute angle A1 can be restated in a way that the acute angle A1a between angles made by the end face 4a and the first side face 7a and the acute angle A1b between angles made by the end face 4b and the second side face 7b are larger than 0 degree and are smaller than 90 degrees. With the above angle setting, that is, with an angle smaller than 90 degrees provided, the intermediate area 6 can be inclined relative to the first area 5a and the second area 5b. Thus, the width of the intermediate area can be further widened, enabling the strength of the intermediate area to improve, as mentioned later using FIG. 10.

Furthermore, in the optical waveguide 20, an angle made by the line, which connects the middle point P5 between the two end points P1 and P2 and the middle point Q5 between the two first halfway points Q1 and Q2, and the line, which connects the middle point Q5 between the two first halfway points Q1 and Q2 and the middle point Q6 between the two second halfway points Q3 and Q4, is an angle A2. The above angle A2 is an interior angle between angles of parts at which the core has an angle change.

According to one or more embodiments of the present invention, this angle A2 is larger than 0 degree and is 90 degrees or smaller, and according to one or more embodiments of the present invention, the angle A2 is 85 degrees or larger, and is 90 degrees or smaller. In the optical waveguide 20, according to one or more embodiments of the present invention the angle A2 is 90 degrees. With the angle A2 set as mentioned above, in addition to the angle setting of the acute angle A1, a crank-type optical waveguide is possible (the angle change is 90 degrees or smaller), and there can be provided an optical waveguide which is suitable for an electronic device provided with a hinge.

It is noted that the optical waveguide 20 has an angle change at two parts of the clad 1 in a plane including the end face 4a and the end face 4b according to one or more embodiments of the present invention. With this configuration, it is easy to form the shape of the optical waveguide 20, resulting in excellent production efficiency.

A state in which the same shapes 11a as that of the optical waveguide 20 adjoin with each other is shown in FIG. 3D. FIG. 3D is a plan view showing the optical waveguide 12, as viewed from the direction toward the surface of the clad. In a similar manner to that of the optical waveguide 10, the same shapes 11a as that of the optical waveguide 20 can adjoin with each other, and by performing very small number of cuttings, i.e. (N−1) time cuttings with respect to the end faces and (N−1) time cuttings with respect to the side faces, the optical waveguides 20 can be efficiently cut out from the optical waveguide material 12.

Here, the first area 5a has a shape characterized such that the two end points P1 and P2 in the first area 5a and the two first halfway points Q1 and Q2 are connected with a straight-line. Also, the second area 5b has a shape characterized such that the two end points P3 and P4 in the second area 5b and the two second halfway points Q3 and Q4 are connected with a straight-line. With the optical waveguide 20 having the above straight-line shape, a shape in case of cutting out the optical waveguide 20 from the optical waveguide 12 is simplified, making a cutting process easy in a manufacturing process of the optical waveguide 20. The above mentioned state that “the optical waveguide 20 has the above straight-line shape” may be regarded as a state that “the first side face 7a and the second side face 7b have a planar shape at least in one portion thereof”.

FIG. 4A is a plan view showing an optical waveguide 20b that is a variant of the optical waveguide 20 in FIG. 3A. The first side face 7a has a curvature at the first halfway point Q1 and the second halfway point Q3, and the second end face 7b has a curvature at the first halfway point Q2 and the second halfway point Q4. In other words, the first side face 7a and the second side face 7b have a shape characterized such that the straight-lines are connected via the curved-lines. A state in which the same shapes 11b as that of the optical waveguide 20b adjoin with each other is shown in FIG. 4B. As shown in FIG. 4B, by cutting the optical waveguide material 12 into the shape 11b, the optical waveguide 20 can be manufactured efficiently.

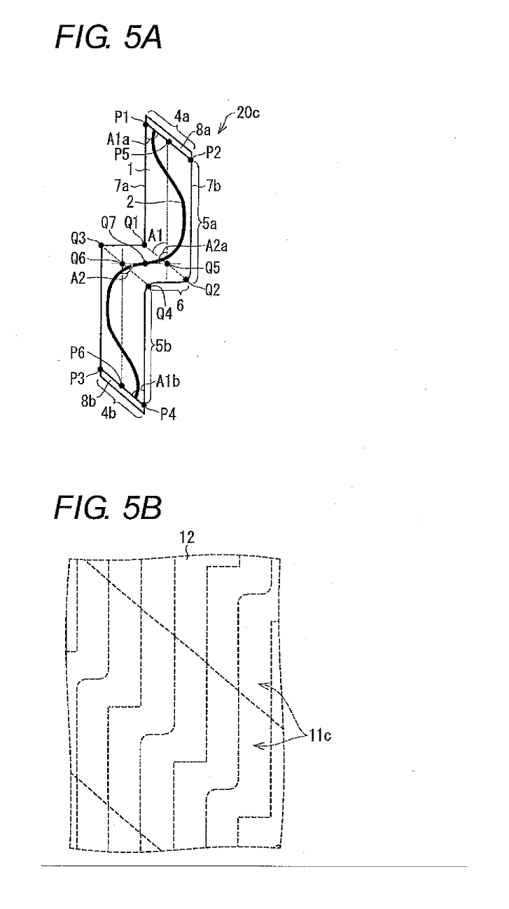

FIG. 5A is a plan view showing an optical waveguide 20c that is a further variant of the optical waveguide 20b in FIG. 4A. The first side face 7a of the optical waveguide 20 does not have a curved-line shape at the first halfway point Q1 and the second halfway point Q3, but the second side face 7b has a curved-line shape at the first halfway point Q2 and the second halfway point Q4. Accordingly, the first side face 7a and the second side face 7b are translationally symmetric with each other, if portions (right angle portions and curved-line portions) corresponding to the four halfway points are excluded.

Thus, even if portions of the end faces are not translationally symmetric, but if side faces excluding a portion of the side faces are translationally symmetric with each other, by cutting the optical waveguide material 12 into a shape 11c and another shape, the curved-line part of which is different from the curved-line part of the shape 11c, the optical waveguide can be manufactured efficiently. That is, it is possible to efficiently manufacture an optical waveguide which has a curved-line shape at the first halfway point Q1 and the second halfway point Q3 or at the first halfway point Q2 and the second halfway point Q4. In addition, a way of forming a curved-line shape can be modified arbitrarily.

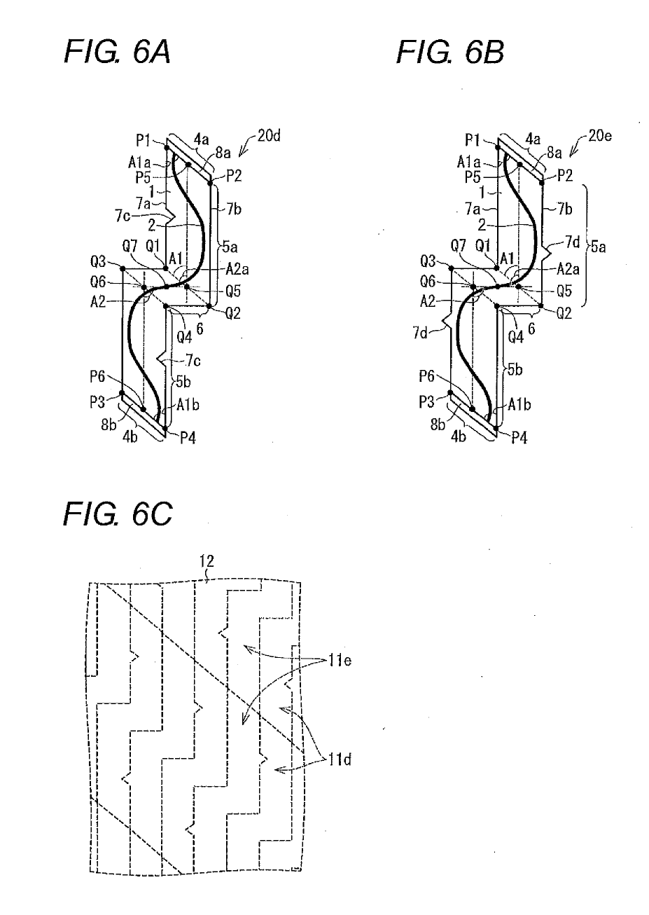

FIG. 6A is a plan view showing an optical waveguide 20d that is a further variant of the optical waveguide 20 in FIG. 3A. In the optical waveguide 20d, a concave part 7c having a concave shape is formed on a portion of the first side face 7a and the second side face 7b. Accordingly, the first side face 7a and the second side face 7b are translationally symmetric with each other, in which the concave part 7c and a straight-line shape corresponding to the concave part 7c are excluded.

On the other hand, in FIG. 6B, unlike the optical waveguide 20d, a convex part 7d having a convex shape, not the concave part 7c, is formed on the first side face 7a and the second side face 7b. Accordingly, the first side face 7a and the second side face 7b are translationally symmetric with each other, in which the convex part 7d and a straight-line shape corresponding to the convex part 7d are excluded. According to such an optical waveguide, the concave shape 7c or convex shape 7d can be used as a mark when the optical waveguide is incorporated in an optical transmission module etc., which can improve accuracy in assembling.

By cutting the optical waveguide 12 as shown in FIG. 6C, it is possible to efficiently manufacture an optical waveguide having the concave part 7c or the convex part 7d. In addition, by changing a shape in case of cutting, it is possible to form an optical waveguide having both the concave part 7c and the convex part 7d.

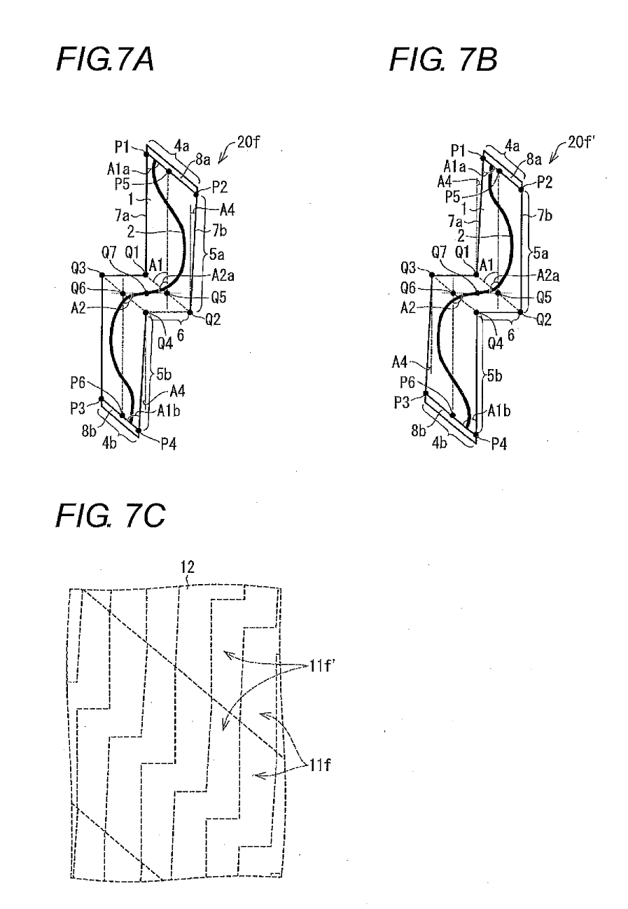

FIG. 7A is a plan view showing an optical waveguide 20f that is a further variant of the optical waveguide 20 in FIG. 3A. In the optical waveguide 20f, a portion of the second side face 7b has inclination relative to a portion of the first side face 7a. That is, when compared to the optical waveguide 20, the second side face 7b inclines outward by an angle A4 from the first halfway point Q2 to the end point P2 and inclines inward by the angle A4 from the second halfway point Q4 to the end point P4.

Accordingly, if the first side face 7a is moved translationally to the second side face 7b, (1) a straight-line connecting the first halfway point Q1 and the second halfway point Q3 coincides with (2) a straight-line connecting the first halfway point Q2 and the second halfway point Q4, and there is a discrepancy in an angle by the angle A4 for the parts having the above inclination.

When there is inclination in this way, although the shape of the first side face 7a is not thoroughly coincident with the that of second side face 7b, there is no change in a fact that the optical waveguide can be manufactured efficiently, and it can be said that the first side face 7a and the second side face 7b are also translationally symmetric with each other in such a case.

With respect to the range of the angle A4, for example, when the ratio of the width and the length (from the first halfway point Q1 to the end point P1) of the optical waveguide is set at 1:5 or larger, it is desirable that the angle A4 is set at a value of 10 degrees or smaller, because the width of the end face is not substantially ensured if the angle A4 is set at a value larger than 10 degrees. Accordingly, according to one or more embodiments of the present invention the angle A4, i.e. an inclination angle, is larger than 0 degree and is 10 degrees or smaller.

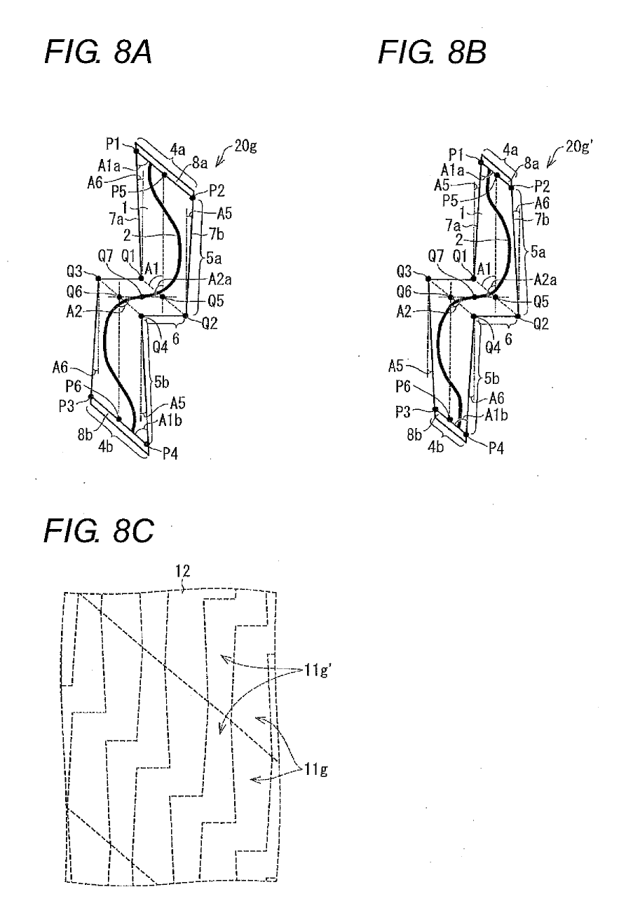

FIG. 8A is a plan view showing an optical waveguide 20g that is a further variant of the optical waveguide 20f in FIG. 7A. The first side face 7a inclines outward by an angle A6 from the first halfway point Q1 to the end point P1, and inclines outward by the angle A6 from the second halfway point Q3 to the end point P3. Furthermore, the side face 7b inclines outward by an angle A5 from the first halfway point Q2 to the end point P2, and inclines outward by the angle A5 from the second halfway point Q4 to the end point P4.

Accordingly, if the second side face 7b is moved translationally to the first side face 7a, (1) a straight-line connecting the first halfway point Q1 and the second halfway point Q3 coincides with (2) a straight-line connecting the first halfway point Q2 and the second halfway point Q4, and there is a discrepancy in an angle by an angle (A5+A6) for the parts having the above inclination.

On the other hand, the optical waveguide 20g′ shown in FIG. 8B is cut out together with the optical waveguide 20g from the optical waveguide material 12 in FIG. 8C. With respect to the range of the angle (A5+A6), for example, when the ratio of the width and the length (from the first halfway point Q1 to the end point P1) of the optical waveguide is set at 1:5 or larger, the width of the end face is not substantially ensured if the angle (A5+A6) is larger than 10 degrees. That is, the widths of the end faces 4a and 4b become too small, making it difficult to design the optical waveguide. Therefore, according to one or more embodiments of the present invention, the inclination angle (A5+A6) is 0 degree or larger and is 10 degrees or smaller.

As a variant of the clad, an optical waveguide 20h is shown in FIG. 9. The optical waveguide 20h has a clad 1′ having an angle change at four parts in a plane including the incident end face and the exiting end face. In the optical waveguide 20h, the first side face 7a and the second side face 7b are translationally symmetric with each other, and by using the same method of cutting out as that in FIG. 1D, there can be provided an optical waveguide with high production efficiency. These things are same as in the optical waveguide 20.

The predominance of the optical waveguide 20 will be described when compared to the optical waveguide 10, using FIG. 10. FIG. 10A is a plan view showing a mobile phone 100 provided with a hinge 103. The mobile phone 100 is provided with an information display section 101 and an information input section 102. On the information input section 102, various kinds of buttons are arranged. On the other hand, the information display section 101 is provided with a display, which is configured so that information from the information input section 102 is displayed on the information display section 101 via an optical waveguide that is located at a middle region and is arranged along the hinge 103.

FIGS. 10B and 10C are plan views, each of which shows a state in which the optical waveguide is arranged along the hinge 103. As shown in FIG. 10B, the middle region, as observed from the direction toward the surface (upper face) of the clad of the optical waveguide 10, is arranged in the region of the hinge 103. That is, the area (intermediate area) that has an angle change relative to the area (first area) including the incident end face in the clad, is arranged on the hinge. In the optical waveguide 10, the first area has a rectangular shape and the intermediate area has a narrower width. As shown in FIG. 10B, in the case of the optical waveguide 10 in which the end face and the small-sized hinge are parallel (in case that the intermediate area is a parallelogram), since the width of the intermediate area is narrow, the strength of the intermediate area cannot be enhanced.

On the other hand, in the optical waveguide 20 shown in FIG. 10C, since the optical waveguide 20 has the acute angles A1 and A2 as shown in FIG. 3C, a wide intermediate area can be arranged along the hinge 103. Since the intermediate area can be designed so as to have the wide width in this way, the strength of the intermediate area can be enhanced, and there can be provided an optical waveguide 20 suitable for a mobile phone 100 provided with a hinge.

Furthermore, the optical waveguide 20 can be widely used not only for a mobile phone provided with a hinge but also for an electronic device such as a PHS (Personal Handyphone System), a PDA (Personal Digital Assistant), a notebook computer, an electronic dictionary, a game machine, which may be provided with other types of hinges. In addition, the optical waveguide 20 can be used for an electronic device that is not provided with a hinge, of course.

Next, the core 2 will be described in more detail. As shown in FIG. 3C, in the optical waveguide 20, the core 2 includes a curved-line shape. That is, at least one portion of the core 2 has a curved-line shape. Thus, until light entering one end face exits from the other end face, optical loss can hardly be produced at the core 2, which realizes small optical coupling loss.

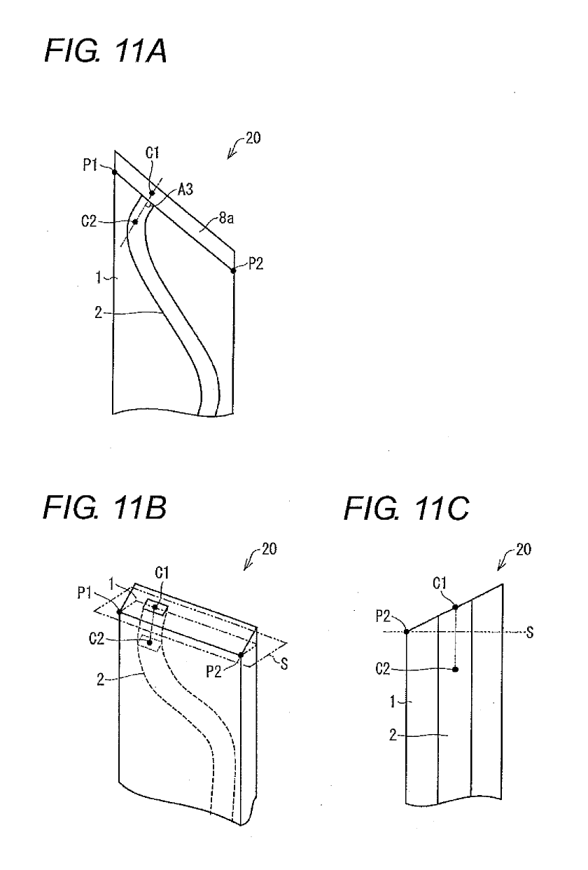

FIG. 11A is a plan view showing the optical waveguide 20 in FIG. 3C, particularly showing the periphery of the reflective surface 8a. FIG. 11B is a perspective view showing the optical waveguide 20. In the optical waveguide according to one or more embodiments of the present invention, and in the shape of the core in a plane parallel to the surface (upper face) of the clad, according to one or more embodiments of the present invention, an angle between angles made between a straight-line, which connects a central point C1 of the core width 0.1 mm distant in the perpendicular direction from at least one end face of the end faces of the first area and the second area and a central point C2 of the core width in the one end face, and a plane 5, which passes through the two end points P1 and P2 in one end face and is perpendicular to the surface of the clad 1, is 75 degrees or larger and is 105 degrees or smaller. The above expression of “in the shape of the core in a plane parallel to the surface (upper face) of the clad” may be restated as “in a plane including the core 2 in the incident end face and the core 2 in the exiting end face”.

Here, the core width, “0.1 mm” distant, is adopted with respect to a reference in determining the angle of the core 2, but this length, “0.1 mm”, is used as a provisional reference. An optical waveguide according to one or more embodiments of the present invention can be produced by at least designing the core 2 based on the above reference.

Specifically, as shown in FIGS. 11A and 11B, according to one or more embodiments of the present invention an angle A3 made between the straight-line, which connects the central point C1 and the central point C2, and the plane S is 90 degrees in the optical waveguide 20.

With the angle A3 being within the above range, when light enters from the end face, the angle of the light relative to the plane S can be perpendicular or an angle close to perpendicular, enabling a suitable light incidence. As a result, optical loss is hardly produced, which enables improved coupling efficiency. Here, the central point of the core width is an intersection point, at which two diagonal lines intersects when the cross section of the core is a square or a rectangle, and is a center when the cross section of the core is a circle or an ellipse. The central point of the core width may be restated as the central point of the cross section of the core. FIG. 11C is a side view corresponding to the optical waveguide 20 of FIGS. 11A and 11B.

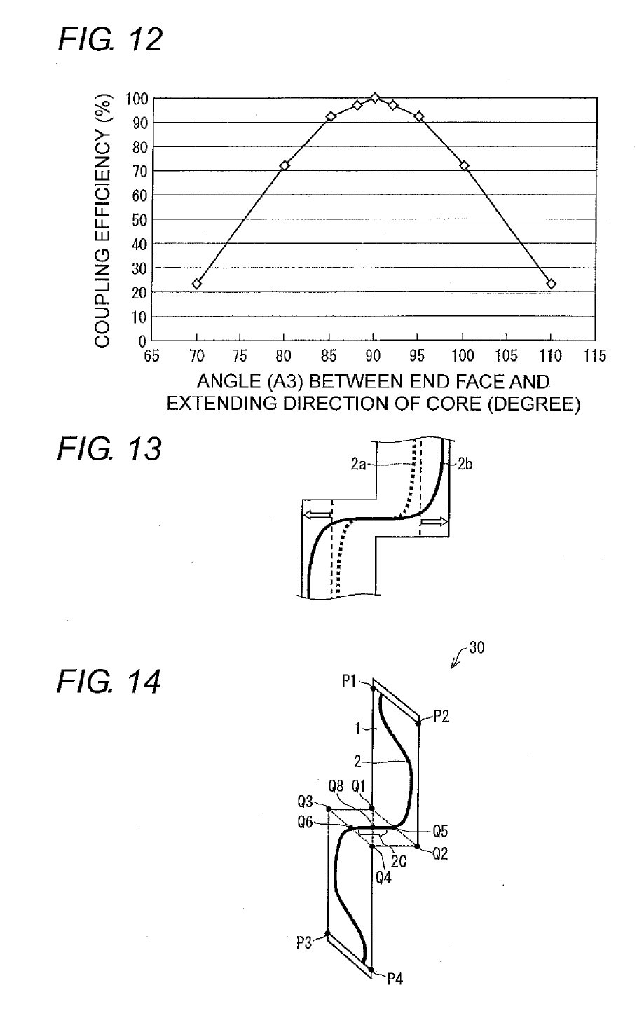

FIG. 12 is a graph showing measured results of coupling efficiency when the angle A3 is varied. As shown in FIG. 12, when the angle A3, at which light enters, is 75 degrees or 105 degrees, the coupling efficiency is about 48%, showing a value for practical use according to one or more embodiments of the present invention. As the angle A3 approaches 90 degrees, the coupling efficiency increases and exhibits 100%, at 90 degrees, according to one or more embodiments of the present invention.

Furthermore, in the optical waveguide according to one or more embodiments of the present invention, the core is formed so as to pass through at least once at least one of a median line of the two side faces in an area including the incident end face in the clad and a median line of the two side faces in an area including the emitting end face in the clad.

If this is explained in FIG. 3C, the median line of the two side faces is a straight-line that connects the middle points P5, Q5, Q6 and P6. That is, in other words, the core 2, as observed from the direction toward the surface (upper face) of the clad 1, is formed so as to pass through at least once at least one of (1) the straight-line, which connects the meddle point of the two end points in one end face and the middle point of the two first halfway points, and (2) the straight-line, which connects the middle point of the two end points in the other end face and the middle point of the two second halfway points.

As shown in FIG. 3C, in the optical waveguide 20, the core 2 is formed so as to pass through (1) the line, which connects the middle point P5 and the middle point Q5, and (2) the line, which connects the middle point P6 and the middle point Q6. Thus, the core 2 is to be formed in a wider area, and it becomes possible to set the maximum curvature of the curved-line shape of the core 2 to be small. As mentioned above, since the angle A3 is 75 degrees or larger and is 105 degrees or smaller, the core 2 has an S shape in the first area 5a and the second area 5b.

According to one or more embodiments of the present invention, the maximum curvature of the curved-line shape of the core 2 is 0.25 mm⁻¹ or smaller. Thus, the core 2 has a smooth shape, and optical loss is hardly produced for the light transmitted in the core 2, which realizes small optical coupling loss.

The width of the clad 1 will be explained in relation to the shape of the core 2. In one or more embodiments of the present invention, the core 2 is formed so that the curvature of the core 2 becomes smaller, because optical loss in the core 2 is more hardly produced with a smaller curvature of the core 2. Accordingly, according to one or more embodiments of the present invention, the width of an area including the incident end face in the clad is larger than the width of an area having an angle change relative to the area including the incident end face and that the width of an area including the exiting end face in the clad is larger than the width of an area having an angle change relative to the area including the exiting end face. If this is explained based on the optical waveguide 20 in FIG. 3C, according to one or more embodiments of the present invention, the width of the first area 5a is larger than the width of the intermediate area 6 and that the width of the second area 5b is larger than the width of the intermediate area 6.

Here, the width of the first area 5a refers to a distance of the first area 5a in the direction perpendicular to the straight-line connecting the middle point P5 and the middle point Q5, and the width of the second area 5b refers to a distance of the second area 5b in the direction perpendicular to the straight-line connecting the middle point P6 and the middle point Q6.

FIG. 13 is a plan view showing an optical waveguide, in which the widths of the first area 5a and the second area 5b are smaller than the width of the intermediate area 6, and another optical waveguide in which the widths of the first area 5a and the second area 5b are widened. As is shown in FIG. 13, it is found that the curvature of a core 2b is smaller than that of a core 2a. Thus, forming the widths of the first area 5b and the second area 5b wider than the width of the intermediate area 6 makes the curvature of the core small, and optical loss in the core can be hardly produced.

In an optical waveguide according to one or more embodiments of the present invention, the core has an inflection point in at least one of an area, which has an angle change relative to an area including the incident end face in the clad, and another area, which has an angle change relative to an area including the exiting end face.

In the optical waveguide 20 in FIG. 3C, since there are two parts that have an angle change, both the area, which has an angle change relative to the area including the incident end face, and the area, which has an angle change relative to the area including the exiting end face, are the intermediate area 6, and the core 2 in the intermediate area 6 has an inflection point Q7.

According to the above shape, since the core 2 can be formed in a shape that is smooth around the inflection point Q7, the optical loss in the core 2 is hardly produced.

On the other hand, a portion of the core 2 in the intermediate area 6 may be formed in a straight-line shape along the median line of the first side face 7a and the second side face 7b. In order to form such a core 2, a design needs to be conducted so that the inflection point Q7 is arranged at a position, which is coincident with the median line of the first side face 7a and the second side face 7b, or at a position parallel to the median line. By also taking a configuration so that the clad 1 and the core 2 arranged on the inflection point are extended along the direction of the median line, an optical waveguide having a straight-line shape can be easily realized. In this manner, there can be provided an optical waveguide in which a tangential line of the inflection point Q7 of the core 2 is coincident with or parallel to the median line of the first side face 7a and the second side face 7b.

An example of the above-mentioned optical waveguide is shown in FIG. 14. FIG. 14 is a plan view showing the optical waveguide 30 that is a variant of the optical waveguide 20, as viewed from the direction toward the surface of a clad 1. The optical waveguide 30 is formed so that the core 2 in the intermediate area 6 passes though a middle point Q8 between the middle point Q5, which is located between the two first halfway points Q1 and Q2, and the middle point Q6, which is located between the two second halfway points Q3 and Q4, along at least a portion of a straight-line that connects the middle point Q5, which is located between the two first halfway points Q1 and Q2, and the middle point Q6, which is located between the two second halfway points Q3 and Q4.

That is, the optical waveguide 30 has a straight-line shape 2C in which the core 2 passes through the middle point Q8. According to the configuration, there is a merit that a change in the shape of the optical waveguide 30 can be easily made by adjusting the length of the straight-line shape 2C, with the shape of the core excluding the straight-line shape 2C remaining unchanged.

<Optical Transmission Module>

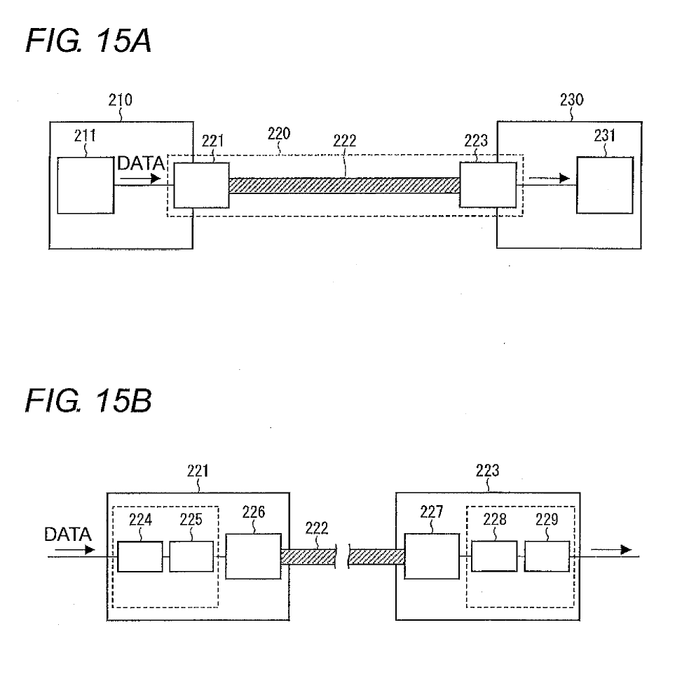

The optical waveguide according to one or more embodiments of the present invention functions as a part of an optical transmission module. The optical transmission module is mounted on various kinds of electronic devices. First, an optical transmission module will be described using FIG. 15. FIG. 15 is a block diagram showing the optical transmission module 200 provided with an optical waveguide, as an example.

As shown in FIG. 15A, the optical transmission module 200 is provided with a CPU (Central Processing Unit)-side board 210, a data line 220 and a LCD (Liquid Crystal Display)-side board 230. In the optical transmission module 200, data is transmitted from a CPU 211 to a light transmitting module 221 and then is transmitted from the light transmitting module 221 through the core of an optical waveguide 222 to a light receiving module 223, and further is transmitted to an LCD 231. The LCD 231 may be replaced by a camera and the like.

Details of the data line 220 are shown in FIG. 15B. The light transmitting module 221 is provided with an I/F circuit 224 and a driver 225, i.e. a transmitting IC. The driver 225 is connected with a light emitting element (light transmitting unit) 226 that makes light enter the optical waveguide 222. On the other hand, in the light receiving module 223, a light receiving element (light receiving unit) 232 that receives light exiting from the optical waveguide 222 is connected with an amplifier 228 and an I/F circuit 229, i.e. a receiving IC. The I/F circuit 229 is further connected with the LCD 231.

The I/F circuit 224 is a circuit for receiving a high-speed data signal from the outside. The I/F circuit 224 is provided between an electrical wiring, through which an electric signal is inputted into the optical transmission module 200, and the driver 225. The I/F circuit 224 may be configured by an IC (Integrated Circuit).

The driver 225 is a light emission driving unit that controls emission from the light emitting element 226 based on an electric signal inputted into the optical transmission module 200 from the outside via the I/F circuit 224. The driver 225 can be configured by an IC for light emission driving, for example.

The light emitting element 226 emits light based on control by the driver 225. The light emitting element 226 can be configured by a light emitting element such as a VCSEL (Vertical Cavity-Surface Emitting Laser), for example.

Light emitted from the light emitting element 226 is applied on one end face (incident end face) of the optical waveguide 222 as an optical signal.

In this way, the light transmitting module 221 converts an electric signal inputted into the light transmitting module 221 to an optical signal corresponding to the electric signal, and outputs the optical signal to the optical waveguide 222.

Next, the light receiving element 227 receives the light as the optical signal exiting from the other end face (exiting end face) of the optical waveguide 222, and outputs an electric signal created by photoelectric conversion. In this case, a photo-detector 31 is configured by a light receiving element such as a PD (Photo-diode), for example. Furthermore, the light receiving element 227 is provided with a detection circuit, although not shown, which judges whether or not the light receiving element 227 receives an optical signal. The detection circuit may be configured by an IC.

The amplifier 228 amplifies the electric signal outputted from the light receiving element 227 and outputs an electric signal with a desirably amplified value to the outside. The amplifier 228 can be configured by an IC for amplification, for example.

The I/F circuit 229 is a circuit that outputs the electric signal amplified by the amplifier 228 to the outside of the optical transmission module 200. The I/F circuit 229 is connected with an electrical wiring that transmits an electric signal to the outside and is provided between the amplifier 228 and the electrical wiring. The I/F circuit 229 may be configured by an IC.

In this way, the light receiving module 223 can receive the optical signal that is outputted from the light transmitting module 221 through the optical waveguide 222, and can output the electric signal with the desirably amplified value to the outside, after converting the optical signal to the electric signal corresponding to the optical signal.

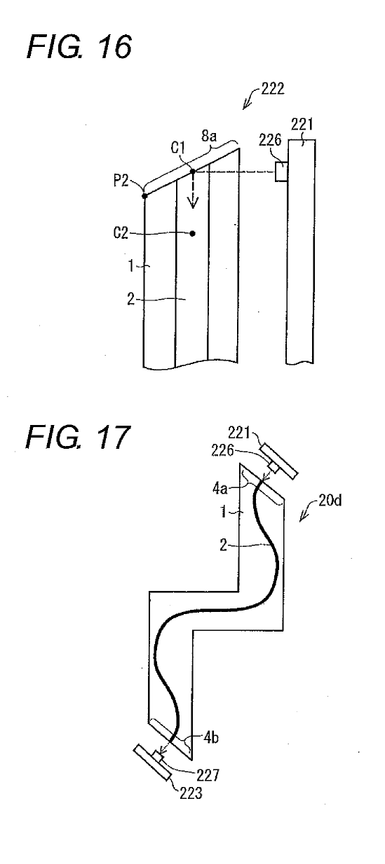

The arrangement of the light emitting element 226 with respect to the optical waveguide 222 according to one or more embodiments of the present invention, more specifically, the arrangement of the both members in case that light is emitted from the light emitting element, will be described using FIG. 16. FIG. 16 is a side view showing the optical waveguide 222, on the end face of which the reflective surface 8a is formed, the CPU-side board 210 and the light emitting element 226.

As shown in FIG. 16, since the optical waveguide 222 according to one or more embodiments of the present invention is provided with the reflective surface 8a, light emitted from the light emitting element 226 suitably enters the core 2. Accordingly, the CPU-side board 210 can be arranged in parallel with the optical waveguide 222, which realizes the low-height mounting of the optical waveguide 222 on the optical transmission module.

In recent years, since a miniaturized and thinner electronic device has been required, there is a significant meaning that the low-height mounting of an optical waveguide is carried out. On the other hand, when the reflective surface 8 does not exist and the end face of the optical waveguide 222 has an angle of 90 degrees, light is required to enter from the direction perpendicular to the core 2. An optical waveguide on which the reflective surface 8 is not formed is shown in FIG. 17. FIG. 17 is a plan view showing an optical waveguide 20d according to one or more embodiments of the present invention. When the reflective surface 8 does not exist, light exiting from the light emitting element 226 enters the core 2 with the advancing direction of the light unchanged at the end face 4a. Furthermore, the light exiting from the end face 4b exits toward the light receiving element 227 with the advancing direction of the light also unchanged. Accordingly, the light transmitting module 221 is arranged in parallel with the end face 4a, and the light receiving module 223 is arranged in parallel with the end face 4b. As a result, it is not possible to carry out the low-height mounting of the light transmitting module 221 and the light receiving module 223 on the optical waveguide 10.

<Electronic Device>

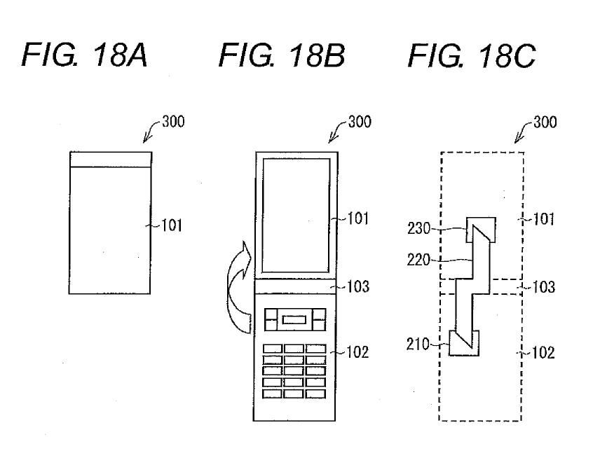

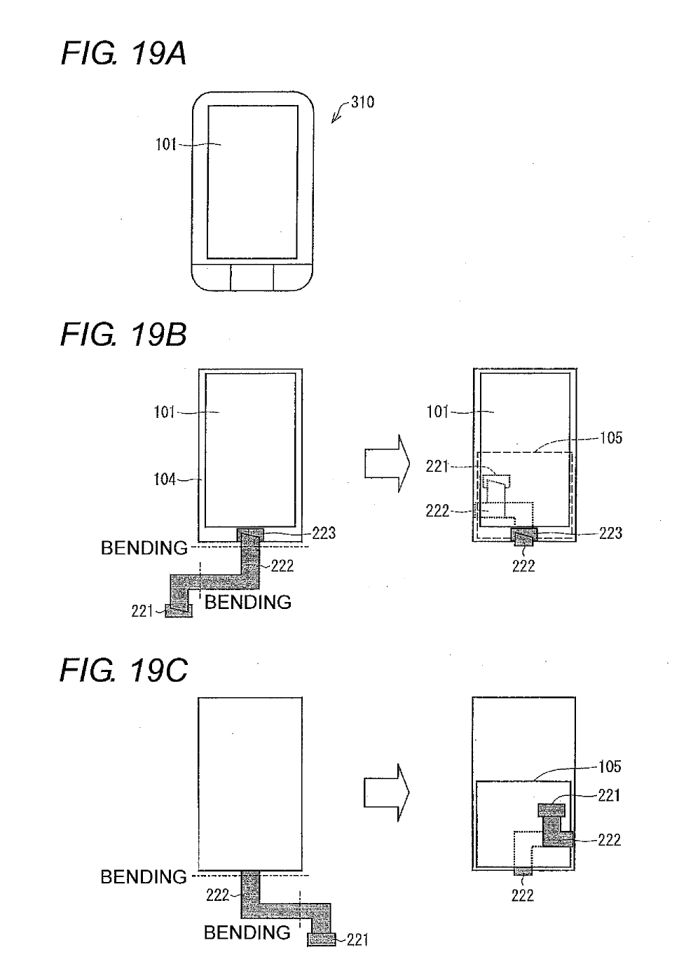

The electronic device according to one or more embodiments of the present invention is provided with the optical transmission module according to one or more embodiments of the present invention. The electronic device includes a mobile phone, a PHS (Personal Handyphone System), a PDA (Personal Digital Assistant), a notebook computer, an electronic dictionary, a game machine and the like. The structure of the electronic device is not limited, in particular. A mobile phone provided with the optical transmission module according to one or more embodiments of the present invention is shown in FIGS. 18 and 19, as an example of the electronic device.

FIG. 18A to 18C are plan views showing a mobile phone (electronic device) 300 provided with the optical transmission module 200 according to one or more embodiments of the present invention. The mobile phone 300 is provided with an information display section 101, an information input section 102 and a hinge 103, and has a foldable structure. That is, the information display section 101 and the information input section 102 are pivotable along the hinge 103 from a folded state, as shown in FIG. 18A. Being pivotable implies being rotatable in positive and negative directions around the axis of the hinge.

The mobile phone 300 is provided with the optical transmission module that includes the optical waveguide 222 having the same shape as that of the optical waveguide 20, and the intermediate area observed from the direction toward the surface of the clad is arranged in the region of the hinge 103. Thus, the strength of the clad in the intermediate area along the hinge 103 can be enhanced and cracks are hardly produced in the optical waveguide 222. As a result, the mobile phone 300 has a structure in which failure frequency is very low.

An example of another mobile phone is shown in FIG. 19. FIG. 19 shows a mobile phone 310. FIG. 19A is a plan view showing the mobile phone 310, and FIGS. 19B and 19C are process drawings showing the manufacturing process of the mobile phone 310. The mobile phone 310 shown in FIG. 19A has a bar-structure (bar type), which is also called a straight-structure (straight type). Unlike a foldable mobile phone, the mobile phone of this structure does not have a part at which the mobile phone is folded. A hinge as shown in the mobile phone 300 does not exist in this bar-structure, but the optical transmission module (optical waveguide) according to one or more embodiments of the present invention can also be used suitably for a mobile phone with a bar-structure.

FIG. 19B shows a state in which the optical transmission module is connected with a lower part of the information display section (LCD) 101. Here, the information display section 101 is surrounded by a frame 104. Typically, it is general that the driver of the information display section 101 is located at the center of a lower part of the information display section 101 or at a center of the information display section 101. FIG. 19C is a plan view showing the information display section 101 etc., as viewed from the opposite face of the information display section 101.

In the optical transmission module according to one or more embodiments of the present invention, the optical waveguide 222 has an angle change at two parts, and in FIGS. 19B and 19C, the optical waveguide 222 is bent along the transverse direction of the information display section 101 and the light transmitting module 221 is moved to the back side of the information display section 101. Next, a disposition substrate provided with a CPU is arranged on the optical waveguide 222, and a structure in which the optical waveguide 222 is sandwiched between the information display section 101 and the disposition substrate 105 is created. Furthermore, the optical waveguide 222 extending from the end part of the disposition substrate 105 is bent at the end part of the disposition substrate 105, and is arranged on the surface of the disposition substrate 105. Then, the optical transmitting module 221 is connected with the disposition substrate 105.

In this way, since the optical transmission module according to one or more embodiments of the present invention is provided with the optical waveguide 222 having an angle change, it can be suitably mounted on the mobile phone 310 by suitably bending the optical waveguide 222. Although the mobile phone provided with the optical transmission module according to one or more embodiments of the present invention has been described as an example in FIG. 19, the optical transmission is not limited to this example, but can be provided on a tablet-type electronic device.

The present invention is not limited to the embodiments described above, and there can be various variants.

The optical waveguide according to one or more embodiments of the present invention is produced with high efficiency, and can be employed in the field of electronic devices that use an optical waveguide.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An optical waveguide comprising:
a clat; and
a core surrounded by the clad and having an index of refraction larger than an index of refraction of the clad;
an incident end face that makes light enter the core; and
an exiting end face that makes light exit from the core,
wherein two side faces of the optical waveguide are formed so as to have an angle change, and
wherein the two side faces are translationally symmetric with each other, or two side faces excluding a portion of the side faces are translationally symmetric with each other.

2. The optical waveguide according to claim 1, wherein the two side faces have an angle change at least at two parts.

3. The optical waveguide according to claim 1, wherein an acute angle between angles made between the incident end face and the side faces and acute angle between angles made between the exiting end face and the side faces are larger than 0 degree and are smaller than 90 degrees.

4. The optical waveguide according to claim 1, wherein an interior angle between angles of parts having an angle change is larger than 0 degree and is 90 degrees or smaller.

5. The optical waveguide according to claim 4, wherein the interior angle is 85 degrees or larger and is 90 degrees or smaller.

6. The optical waveguide according to claim 1, wherein,
in a plane including the core in the incident end face and the core in the exiting end face, one angle between angles made between a straight-line that connects a central point of a core width in a position 0.1 mm distant in a perpendicular direction from at least one end face of the incident end face and the exiting end face and a central point of a core width in the one end face, and at least the one end face is 75 degrees or larger and is 105 degrees or smaller.

7. The optical waveguide according to claim 1, wherein the core includes a curved-line shape.

8. The optical waveguide according to claim 7, wherein the core is formed so as to pass through at least once at least one between a median line of two side faces in an area including the incident end face in the clad and a median line of two side faces in an area including the exiting end face in the clad.

9. The optical waveguide according to claim 7, wherein a maximum curvature of the curved-line shape of the core is 0.25 mm⁻¹ or smaller.

10. The optical waveguide according to claim 2,
wherein a width of an area including the incident end face in the clad is larger than a width of an area having an angle change relative to an area including the incident end face, and
wherein a width of an area including the exiting end face in the clad is larger than a width of an area having an angle change relative to an area including the exiting end face.

11. The optical waveguide according to claim 2, wherein a portion of the core is formed in a straight-line shape along a median line of the two side faces, in a plane including the incident end face and the exiting end face.

12. The optical waveguide according to claim 2, wherein the core has an inflection point, in at least one between an area having an angle change relative to an area including the incident end face and an area having an angle change relative to an area including the exiting end face.

13. The optical waveguide according to claim 1,
wherein side faces excluding a portion of the side faces are translationally symmetric with each other, and
wherein a portion of the side faces is a concave shape or a convex shape.

14. The optical waveguide according to claim 1, wherein a reflective surface that makes light enter the core or makes light exit from the core is formed on the incident end face and the exiting end face.

15. The optical waveguide according to claim 1, wherein an electrical wiring is laminated on the clad.

16. An optical transmission module comprising:
the optical waveguide according to claim 1;
a light transmitting unit that makes light enter the incident end face to transmit information; and
a light receiving unit that receives light exiting from the exiting end face to receive information.

17. An electronic device including the optical transmission module according to claim 16.

18. The electronic device according to claim 17, further comprising:
an information input section;
an information display section; and
a hinge,
wherein the information input section and the information display section are pivotable along the hinge and are configured in a foldable structure, and
wherein an area having an angle change relative to an area including the incident end face of in the clad is arranged on the hinge.
